(19) United States
(12) Patent Application Publication
(10) Pub. No.: US 2016/0085798 A1
(43) Pub. Date: Mar. 24, 2016

(54) METHOD AND SYSTEM FOR STORING USER INFORMATION

(71) Applicant: TENCENT TECHNOLOGY (SHENZHEN) COMPANY LIMITED, Shenzhen (CN)

(72) Inventors: Hongjie WU, Shenzhen (CN); Zhongwei LI, Shenzhen (CN); Ming TIAN, Shenzhen (CN)

(21) Appl. No.: 14/962,225

(22) Filed: Dec. 8, 2015

Related U.S. Application Data
(63) Continuation of application No. PCT/CN2014/075555, filed on Apr. 17, 2014.

(30) Foreign Application Priority Data
Jun. 8, 2013 (CN) 201310227544.7

(51) Int. Cl. G06F 17/30

(52) U.S. Cl. CPC G06F 17/30371; G06F 17/3033; G06F 17/30477

(57) ABSTRACT

According to an embodiment, in a first storing system, a record corresponding to an account number ID is stored. In the record, a primary key is the account number ID, and a value is an account number mode and an account number name of the account number. The second storing system obtains the account number and the account number ID from the first storing system, determines whether the account number satisfies the preset reverse-searching condition. If yes, the second storing system generates and stores a record. In the record, a primary key is the account number mode and the account number name of the account number, and a value is the account number ID.

### INCORPORATION BY REFERENCE TO ANY PRIORITY APPLICATIONS

This application is continuation of international application No. PCT/CN2014/075555, filed on Apr. 17, 2014, which claims to the benefit of Chinese Patent Application No. 201310227544.7, filed on Jun. 8, 2013, which is hereby incorporated by reference in its entirety.

### BACKGROUND

1. Field

The present disclosure relates to computer technologies, more particularly to, a method and system for storing user information.

2. Description of the Related Art

Along with development of computer technologies, many applications are provided for users. For example, by using a Micro Blog application, users may distribute information by using various terminal devices and share the information with others instantly.

In the application, e.g. the Micro Blog application, a user is identified by using a unique account number identification (ID), and the account number ID is generally generated by a system automatically, and then assigned to the user.

Generally, the account number ID is a random character string and is not easy to remember. The Micro Blog application provides other account numbers that may be configured by the user, e.g. a login name, a nickname and, and so on.

In practical applications, account number configuration services provided by the applications, e.g. the Micro Blog application, for the user may be called user name services. In the user name service, the account number may be configured by the user, and the account number configured by the user is associated with the account number ID of the user. In addition, in the user name service, the account number may be searched for according to the account number ID, i.e. a reverse-searching operation may be performed.

In conventional technologies, one database table is configured for each account number ID. The account number ID is a primary key, and the account numbers corresponding to the account number ID are remaining fields, so that the account number ID and each of the account numbers corresponding to the account number ID are associated.

### SUMMARY

Embodiments of the present disclosure provide a method and system for storing user information, so as to reduce time delay for reverse-searching operations.

A method for storing user information includes: determining, by a first storing system, whether the first storing system stores a record corresponding to an account number identification (ID), after obtaining an account number corresponding to the account number ID and the account number satisfies a preset reverse-searching condition; if the first storing system does not store the record corresponding to the account number ID, generating and storing, by the first storing system, a record; a primary key of the record being the account number ID, and a value of the record being an account number mode of the account number and an account number name of the account number; if the first storing system stores the record corresponding to the account number ID, taking, by the first storing system, an account number mode of the account number and an account number name of the account number as a value; and adding the value into the record corresponding to the account number ID; obtaining, by the second storing system, the account number and the account number ID from the first storing system; determining, by the second storing system, whether the account number satisfies the preset reverse-searching condition; and when determining the account number satisfies the preset reverse-searching condition, generating and storing, by the second storing system, a record; a primary key of the record being the account number mode of the account number and the account number name of the account number, and a value of the record being the account number ID, and the record being used when searching for the account number ID according to the account number mode of the account number and the account number name of the account number.

A system for storing user information includes: a first storing system, to determine whether the first storing system stores a record corresponding to an account number ID, after obtaining an account number corresponding to the account number ID and the account number satisfies a preset reverse-searching condition; if the first storing system does not store the record corresponding to the account number ID, generate and store a record, a primary key of the record being the account number ID, and a value of the record being an account number mode of the account number and an account number name of the account number; if the first storing system stores the record corresponding to the account number ID, take an account number mode of the account number and an account number name of the account number as a value, and add the value into the record corresponding to the account number ID; and a second storing system, to obtain the account number and the account number ID from the first storing system; when determining the account number satisfies the preset reverse-searching condition, generate and store a record, a primary key of the record being the account number mode of the account number and the account number name of the account number, and a value of the record being the account number ID; and the record being used when searching for the account number ID according to the account number mode of the account number and the account number name of the account number.

A first storing system includes: a first processing module, to send an account number and an account number ID, after obtaining the account number corresponding to the account number ID; and a second processing module, to receive the account number and the account number ID from the first processing module; when determining the account number satisfies a preset reverse-searching condition, determine whether the first storing system stores a record corresponding to the account number ID; if the first storing system does not store the record corresponding to the account number ID, generate and store a record, a primary key of the record being the account number ID, and a value of the record being an account number mode of the account number and an account number name of the account number; if the first storing system stores the record corresponding to the account number ID, take an account number mode of the account number and an account number name of the account number as a value, and add the value into the record corresponding to the account number ID.

A second storing system includes: a third processing module, to obtain an account number and an account number ID from a first storing system, and send the account number and the account number ID; and a fourth processing module, to receive the account number and the account number ID from the third processing module; when determining the account number satisfies a preset reverse-searching condition, generate and store a record, a primary key of the record being an account number mode of the account number and an account number name of the account number, and a value of the record is the account number ID; the record being used when searching for the account number ID according to the account number mode of the account number and the account number name of the account number.

According to the technical solutions of the present disclosure, when storing the account number ID and the account numbers corresponding to the account number ID, different storing solutions are used. In the first storing system, the primary key is the account number ID, and the value is the account number mode and account number name of the account number corresponding to the account number ID. In the second storing system, the primary key is the account number mode and account number name of the account number corresponding to the account number ID, and the value is the account number ID. Therefore, by using the first storing system, the account number ID is associated with each account number corresponding to the account number ID, and by using the second storing system, the reverse-searching operation may be performed, e.g. the account number ID may be searched out according to the account number mode and account number name of the account number. Compared with the conventional solutions, the technical solutions of the present disclosure are more flexible and have better extensibility. Further, the time delay when performing the reverse-searching is reduced and availability is improved.

### BRIEF DESCRIPTION OF THE DRAWINGS

FIG. 1 is a schematic flowchart illustrating a method for storing user information according to various embodiments of the present disclosure.

FIG. 2 is a schematic diagram illustrating a user information storing mode in a first storing system and a second storing system according to various embodiments of the present disclosure.

FIG. 3 is a schematic diagram illustrating a system for storing user information according to various embodiments of the present disclosure.

FIG. 4 is a schematic diagram illustrating a structure of a first storing system according to various embodiments of the present disclosure.

FIG. 5 is a schematic diagram illustrating a structure of a second storing system according to various embodiments of the present disclosure.

### DETAILED DESCRIPTION

The following description is merely illustrative in nature and is in no way intended to limit the disclosure, its application, or uses. The broad teachings of the disclosure can be implemented in a variety of forms. Therefore, while this disclosure includes particular embodiments, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of embodiments anywhere in this specification, including embodiments of any terms discussed herein, is illustrative only, and in no way limits the scope and meaning of the disclosure or of any exemplified term. Likewise, the disclosure is not limited to various embodiments given in this specification.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules may be executed using a single (shared) processor. In addition, some or all code from multiple modules may be stored by a single (shared) memory. The term “group”, as used herein, means that some or all code from a single module may be executed using a group of processors. In addition, some or all code from a single module may be stored using a group of memories.

The systems and methods described herein may be implemented by one or more computer programs executed by one or more processors. The computer programs include processor-executable instructions that are stored on a non-transitory tangible computer readable medium. The computer programs may also include stored data. Non-limiting embodiments of the non-transitory tangible computer readable medium are nonvolatile memory, magnetic storage, and optical storage.

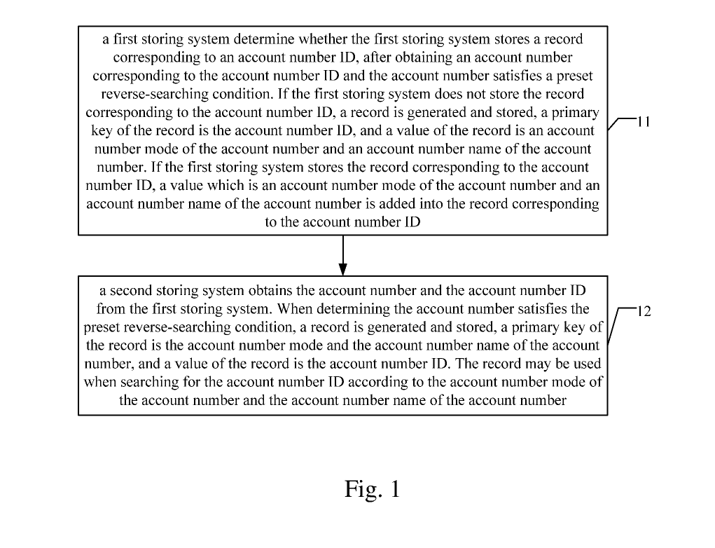

The description below will be made in conjunction with the accompanying drawings in FIGS. 1-5. It should be understood that specific embodiments described herein are merely intended to explain the present disclosure, but not intended to limit the present disclosure. In accordance with the purposes of this disclosure, as embodied and broadly described herein, this disclosure, in one aspect, relates to a method and apparatus for storing user information.

Embodiments of mobile terminals that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to those skilled in the art.

In the method of searching for the account number ID according to the account number, since an index cannot be created by using non-primary key field, the time delay is large and availability is not high.

FIG. 1 is a schematic flowchart illustrating a method for storing user information according to various embodiments of the present disclosure. As shown in FIG. 1, the method includes the following processing.

At 11, a first storing system determine whether the first storing system stores a record corresponding to an account number ID, after obtaining an account number corresponding to the account number ID and the account number satisfies a preset reverse-searching condition. If the first storing system does not store the record corresponding to the account number ID, a record is generated and stored, a primary key of the record is the account number ID, and a value of the record is an account number mode of the account number and an account number name of the account number. According to an embodiment, the account number name is an account number name of the account number in the account number mode. If the first storing system stores the record corresponding to the account number ID, a value which is an account number mode of the account number and an account number name of the account number is added into the record corresponding to the account number ID.

At 12, a second storing system obtains the account number and the account number ID from the first storing system. When determining the account number satisfies the preset reverse-searching condition, a record is generated and stored, a primary key of the record is the account number mode and the account number name of the account number, and a value of the record is the account number ID. The record may be used when searching for the account number ID according to the account number mode of the account number and the account number name of the account number.

As can be seen, by using the solutions of the embodiments of the present disclosure, for any account number ID, when storing the account number ID and each account number corresponding to the account number ID in the first storing system, the account number ID is taken as the primary key, and the account number mode and the account number name of each account numbers corresponding to the account number ID are taken as the value. When storing the account number ID and each account number corresponding to the account number ID in the second storing system, the account number mode and the account number name of each account numbers corresponding to the account number ID are taken as the primary key, and the account number ID is taken as the value.

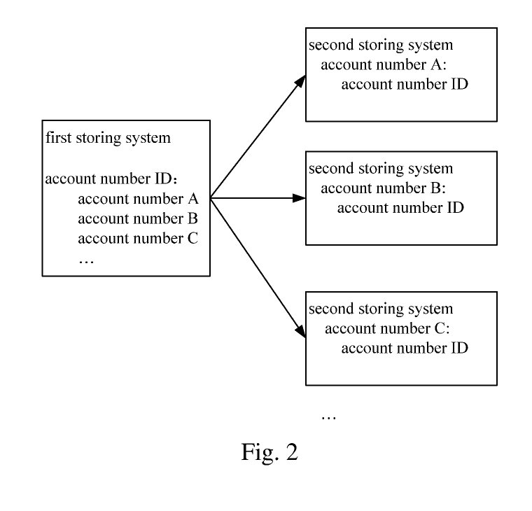

FIG. 2 is a schematic diagram illustrating a user information storing mode in a first storing system and a second storing system according to various embodiments of the present disclosure. As shown in FIG. 2, each box corresponds to one record.

In the record stored in the first storing system or the second storing system, the account number mode is indicated by a preset integer. For example, 2 is used to indicate the account number mode of a login name, and 4 is used to indicate the account number mode of a nickname.

The first storing system may provide a reading-writing service by taking the account number ID as the primary key, and the second system may provide a reverse-seeking interface for the first storing system and externals.

In practical applications, for any account number corresponding to any account number ID, the condition may be as follows.

1) The account number name of the account number is unique in the account number mode of the account number.

For example, the account number mode of the account number is the nick name, and then the account number name of the account number needs to be not identical with a nickname of other users.

2) The account number name of the account number is unique, in both the account number mode of the account number and at least one other account number mode.

For example, the account number mode of the account number is the nick name, and the other account number mode is the login name, then the account number name of the account number needs to be not identical with a nickname or a login name of other users and not identical with a login name of the account number.

According to an embodiment, an interaction procedure between the first storing system and the second storing system may include the following processing.

1) When the account number name of the account number needs to be unique in the account number mode of the account number, i.e. when the reverse-searching condition comprises the account number name of the account number is unique in the account number mode of the account number, the first storing system sends the account number name and the account number mode of the account number to the second storing system. The second storing system determines whether the second storing system stores a record satisfying a first determining condition, and the first determining condition includes that an account number mode and an account number name in a primary key are identical with the account number mode and the account number name of the account number respectively. If there is no record satisfying the first determining condition, the second storing system determines that the account number satisfies the reverse-searching condition, and notifies the first storing system. If there is the record satisfying the first determining condition, the second storing system determines that the account number does not satisfy the reverse-searching condition, and notifies the first storing system. Correspondingly, the first storing system may prompt a user to modify the account number name of the account number until the account number satisfies the reverse-searching condition.

According to an embodiment, when determining whether the second storing system stores a record satisfying a first determining condition, the second storing system may calculate a hash value according to the integer corresponding to the account number mode of the account number and the account number name of the account number, search out a storing unit corresponding to the hash value from all storing units of the second storing system, and determine whether the storing unit searched out stores the record satisfying the first determining condition. The modes for calculating the hash value may refer to conventional technologies.

According to an embodiment, there may be one or multiple storing units corresponding to the hash value. When there are multiple storing units corresponding to the hash value, the second storing system determines whether each of the multiple storing unit stores the record satisfying the first determining condition. If any one of the multiple storing unit stores the record satisfying the first determining condition, the account number is determined as not satisfies the reverse-searching condition.

2) When the account number name of the account number needs to be unique in both the account number mode of the account number and at least one other account number mode, i.e. when the reverse-searching condition comprises the account number name of the account number is unique in both the account number mode of the account number and at least one other account number mode, the first storing system sends the account number name and the account number mode of the account number to the second storing system. The second storing system determines whether the second storing system stores a record satisfying a second determining condition. The second determining condition includes that an account number mode in a primary key of the record is identical with the account number mode of the account number or identical with the at least one other account number mode, and an account number name in the primary key is identical with the account number name of the account number. If there is no record satisfying the second determining condition, the second storing system determines that the account number satisfies the reverse-searching condition, and notifies the first storing system. If there is a record satisfying the second determining condition, the second storing system determines that the account number does not satisfy the reverse-searching condition, and notifies the first storing system. Correspondingly, the first storing system may prompt a user to modify the account number name of the account number until the account number satisfies the reverse-searching condition.

According to an embodiment, when determining whether the second storing system stores a record satisfying a second determining condition, the second storing system may map the integer corresponding to the account number mode of the account number to an integer according to a preset mapping rule, calculate a hash value according to the mapped integer and the account number name of the account number, search out a storing unit corresponding to the hash value from all storing units of the second storing system, and determine whether the storing unit searched out stores the record satisfying the first determining condition.

For example, the account number mode of the account number is the nick name, the other account number mode is the login name, the integer corresponding to the login name is 2, the integer corresponding to the nick name is 4, and the preset mapping rule is {2, 4}->{5}, thus the integer corresponding to the login name is mapped to 5, and the integer corresponding to the nickname is mapped to 5.

According to the above descriptions, after determining that the account number satisfies the reverse-searching condition, the second storing system generates and stores a record. The primary key of the record is the account number mode and account number name of the account number, and a value of the record is the account number ID.

According to an embodiment, the generated record may be stored in a storing unit corresponding to the calculated hash value. When the calculated hash value corresponds to multiple storing units, one of the multiple storing units may be selected, e.g. a storing unit with enough storing space may be selected, and the generated record may be stored in the selected storing unit.

According to an embodiment, the account number ID may be sent by the first storing system to the second storing system separately or when sending the account number mode and account number name of the account number, which is not limited in the present disclosure.

In practical application, if the account number name of the account number does not need to be unique, the first storing system may only store the account number itself, and does not store the account number in the second system, so as to avoid unsuccessful reverse-seeking related to the account number. According to an embodiment, the first storing system determines whether the first storing system stores the record corresponding to the account number ID. If the first storing system does not store the record corresponding to the account number ID, a record is generated and stored. The primary key of the record is the account number ID, and a value of the record is the account number mode and account number name of the account number. If the first storing system stores the record corresponding to the account number ID, the account number mode and account number name of the account number is taken as a value and added to the record corresponding to the account number ID.

According to an embodiment, the second storing system may search for the account number ID according to the account number mode of the account number and the account number name of the account number.

When the account number name of the account number needs to be unique in the account number mode of the account number, the second storing system may calculate a hash value according to the integer corresponding to the account number mode of the account number and the account number name of the account number, search out a storing unit corresponding to the hash value from all storing units of the second storing system, and determine whether the storing unit searched out stores a record, an account number mode and an account number name in a primary key of the record are identical with the account number mode and the account number name of the account number respectively. If the storing unit searched out stores the record, an account number ID in the record is taken as an account number ID searched out.

When the account number name of the account number needs to be unique in both the account number mode of the account number and at least one other account number mode, the second storing system may map the integer corresponding to the account number mode of the account number to a preset integer, and calculate a hash value according to the mapped integer and the account number name of the account number, search out a storing unit corresponding to the hash value from all storing units of the second storing system, and determine whether the storing unit searched out stores a record, an account number mode and an account number name in a primary key of the record are identical with the account number mode and the account number name of the account number respectively. If the storing unit searched out stores the record, an account number ID in the record is taken as an account number ID searched out.

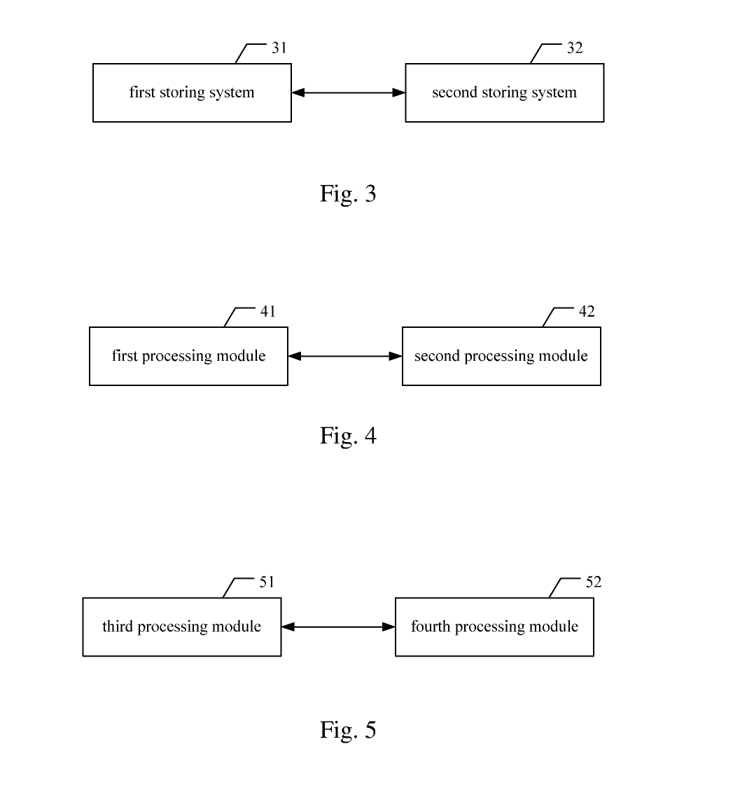

FIG. 3 is a schematic diagram illustrating a system for storing user information according to various embodiments of the present disclosure. As shown in FIG. 3, the system includes a first storing system 31 and a second storing system 32.

The first storing system 31 is to determine whether the first storing system stores a record corresponding to an account number ID, after obtaining an account number corresponding to the account number ID and the account number satisfies a preset reverse-searching condition. If the first storing system does not store the record corresponding to the account number ID, the first storing system 31 is to generate and store a record, a primary key of the record is the account number ID, and a value of the record is an account number mode of the account number and an account number name of the account number. If the first storing system stores the record corresponding to the account number ID, the first storing system 31 is to take an account number mode of the account number and an account number name of the account number as a value, and add the value into the record corresponding to the account number ID.

The second storing system 32 is to obtain the account number and the account number ID from the first storing system 31. When determining the account number satisfies the preset reverse-searching condition, the second storing system 31 is to generate and store a record, a primary key of the record is the account number mode of the account number and the account number name of the account number, and a value of the record is the account number ID. The record may be used when searching for the account number ID according to the account number mode of the account number and the account number name of the account number.

FIG. 4 is a schematic diagram illustrating a structure of a first storing system according to various embodiments of the present disclosure. As shown in FIG. 4, the first system includes a first processing module 41 and a second processing module 42.

The first processing module 41 is to send an account number and an account number ID to the second processing module 42 after obtaining the account number corresponding to the account number ID.

The second processing module 42 is to receive the account number and the account number ID from the first processing module; when determining the account number satisfies a preset reverse-searching condition, determine whether the first storing system stores a record corresponding to the account number ID. If the first storing system does not store the record corresponding to the account number ID, the second processing module 42 is to generate and store a record, a primary key of the record is the account number ID, and a value of the record is an account number mode of the account number and an account number name of the account number. If the first storing system stores the record corresponding to the account number ID, the second processing module 42 is to take an account number mode of the account number and an account number name of the account number as a value, and add the value into the record corresponding to the account number ID.

According to an embodiment, the reverse-searching condition may include that: the account number name of the account number is unique in the account number mode of the account number; or the account number name of the account number is unique, in both the account number mode of the account number and at least one other account number mode.

According to an embodiment, the second processing module 42 is further to prompt a user to modify the account number name of the account number when determining the account number does not satisfy the reverse-searching condition.

According to an embodiment, the second processing module 42 is further to, if the account number name of the account number does not need to be unique, determine whether the first storing system stores the record corresponding to the account number ID. If the first storing system does not store the record corresponding to the account number ID, the second processing module 42 is to generate and store a record, a primary key of the record is the account number ID, and a value of the record is the account number mode and account number name of the account number. If the first storing system stores the record corresponding to the account number ID, the second processing module 42 is to take an account number mode of the account number and an account number name of the account number as a value and add the value to the record corresponding to the account number ID.

FIG. 5 is a schematic diagram illustrating a structure of a second storing system according to various embodiments of the present disclosure. As shown in FIG. 4, the second system includes a third processing module 51 and a second processing module 52.

The third processing module 51 is to obtain an account number and an account number ID from a first storing system, and send the account number and the account number ID to the fourth processing module 52.

The fourth processing module 52 is to receive the account number and the account number ID from the third processing module 51, when determining the account number satisfies a preset reverse-searching condition, generate and store a record, a primary key of the record is an account number mode of the account number and an account number name of the account number, and a value of the record is the account number ID. The record is used when searching for the account number ID according to the account number mode of the account number and the account number name of the account number.

According to an embodiment, the reverse-searching condition may include that: the account number name of the account number is unique in the account number mode of the account number; or the account number name of the account number is unique, in both the account number mode of the account number and at least one other account number mode.

When the account number name of the account number needs to be unique in the account number mode of the account number, the fourth processing module 52 is to determine whether the second storing system stores a record satisfying a first determining condition, and the first determining condition includes that an account number mode and an account number name in a primary key of the record are identical with the account number mode and the account number name of the account number respectively. If there is no record satisfying the first determining condition, the fourth processing module 52 is to determine that the account number satisfies the reverse-searching condition. If there is the record satisfying the first determining condition, the fourth processing module 52 is to determine that the account number does not satisfy the reverse-searching condition.

When the account number name of the account number needs to be unique in both the account number mode of the account number and at least one other account number mode, the fourth processing module 52 is to determine whether the second storing system stores a record satisfying a second determining condition. The second determining condition includes that an account number mode in a primary key of the record is identical with the account number mode of the account number or is identical with the at least one other account number mode, and an account number name in the primary key of the record is identical with the account number name of the account number. If there is no record satisfying the second determining condition, the fourth processing module 52 is to determine that the account number satisfies the reverse-searching condition. If there is the record satisfying the second determining condition, the fourth processing module 52 is to determine that the account number does not satisfy the reverse-searching condition.

According to an embodiment, the account number mode in the record is indicated by using a preset integer.

According to an embodiment, the fourth processing module 52 is to calculate a hash value according to an integer corresponding to the account number mode of the account number and the account number name of the account number, search out a storing unit corresponding to the hash value from all storing units of the second storing system, and determine whether the storing unit searched out stores the record satisfying the first determining condition.

According to an embodiment, the fourth processing module 52 is to map the integer corresponding to the account number mode of the account number to an integer according to a preset mapping rule, calculate a hash value according to the mapped integer and the account number name of the account number, search out a storing unit corresponding to the hash value from all storing units of the second storing system, and determine whether the storing unit searched out stores the record satisfying the second determining condition.

According to an embodiment, the fourth processing module 52 is to generate a record and store the record to a storing unit corresponding to the hash value, a primary key of the record is the account number mode and account number name of the account number, a value of the record is the account number ID.

According to an embodiment, the fourth processing module 52 is further to search for the account number ID according to the account number mode of the account number and the account number name of the account number.

When the account number name of the account number needs to be unique in the account number mode of the account number, the fourth processing module 52 is to calculate a hash value according to the integer corresponding to the account number mode of the account number and the account number name of the account number, search out a storing unit corresponding to the hash value from all storing units of the second storing system, and determine whether the storing unit searched out stores a record, an account number mode and an account number name in a primary key of the record are identical with the account number mode and the account number name of the account number respectively, If the storing unit searched out stores the record, the fourth processing module 52 is to take an account number ID in the record as an account number ID searched out.

When the account number name of the account number needs to be unique in both the account number mode of the account number and at least one other account number mode, the fourth processing module 52 is to map an integer corresponding to the account number mode of the account number to a preset integer, and calculate a hash value according to the mapped integer and the account number name of the account number, search out a storing unit corresponding to the hash value from all storing units of the second storing system, and determine whether the storing unit searched out stores a record, an account number mode and an account number name in a primary key of the record are identical with the account number mode and the account number name of the account number respectively. If the storing unit searched out stores the record, the fourth processing module 52 is to take an account number ID in the record as an account number ID searched out.

According to an embodiment, operations performed by the above system may refer to the description of the method, and will not be described herein.

The methods and modules described herein may be implemented by hardware, machine-readable instructions or a combination of hardware and machine-readable instructions. Machine-readable instructions used in the embodiments disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided, which is to store instructions to cause a machine to execute a method as described herein. Specifically, a system or apparatus having a storage medium that stores machine-readable program codes for implementing functions of any of the above embodiments and that may make the system or the apparatus (or CPU or MPU) read and execute the program codes stored in the storage medium.

In this situation, the program codes read from the storage medium may implement any one of the above embodiments, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

It should be noted that, alternatively to the program codes being executed by a computer, at least part of the operations performed by the program codes may be implemented by an operation system running in a computer following instructions based on the program codes to realize a technical scheme of any of the above embodiments.

In addition, the program codes implemented from a storage medium are written in a storage in an extension board inserted in the computer or in a storage in an extension unit connected to the computer. In this embodiment, a CPU in the extension board or the extension unit executes at least part of the operations according to the instructions based on the program codes to realize a technical scheme of any of the above embodiments.

The foregoing is only preferred embodiments of the present disclosure and is not used to limit the protection scope of the present disclosure. Any modification, equivalent substitution and improvement are within the protection scope of the present disclosure.

What is claimed is:

1. A method for storing user information, comprising:
determining, by a first storing system, whether the first storing system stores a record corresponding to an account number identification (ID), after obtaining an account number corresponding to the account number ID and the account number satisfies a preset reverse-searching condition;
if the first storing system does not store the record corresponding to the account number ID, generating and storing, by the first storing system, a record, a primary key of the record being the account number ID, and a value of the record being an account number mode of the account number and an account number name of the account number;
if the first storing system stores the record corresponding to the account number ID, taking, by the first storing system, an account number mode of the account number and an account number name of the account number as a value, and adding the value into the record corresponding to the account number ID;
obtaining, by the second storing system, the account number and the account number ID from the first storing system;
determining, by the second storing system, whether the account number satisfies the preset reverse-searching condition; and
when determining the account number satisfies the preset reverse-searching condition, generating and storing, by the second storing system, a record, a primary key of the record being the account number mode of the account number and the account number name of the account number, and a value of the record being the account number ID, and the record being used when searching for the account number ID according to the account number mode of the account number and the account number name of the account number.

2. The method of claim 1, further comprising:
prompting, by the first storing system, a user to modify the account number name of the account number when determining the account number does not satisfy the reverse-searching condition.

3. The method of claim 1, wherein the reverse-searching condition comprises:
the account number name of the account number being unique in the account number mode of the account number; or
the account number name of the account number being unique in both the account number mode of the account number and at least one other account number mode.

4. The method of claim 3, further comprising:
determining, by the first storing system, whether the first storing system stores a record corresponding to an account number ID, if the account number name does not need to be unique;
if the first storing system does not store the record corresponding to the account number ID, generating and storing, by the first storing system, a record, a primary key of the record being the account number ID, and a value of the record being an account number mode of the account number and an account number name of the account number; and
if the first storing system stores the record corresponding to the account number ID, taking, by the first storing system, an account number mode of the account number and an account number name of the account number as a value; and adding the value into the record corresponding to the account number ID.

5. The method of claim 3, wherein
when the reverse-searching condition comprises the account number name of the account number being unique in the account number mode of the account number, determining, by the second storing system, whether the account number satisfies the preset reverse-searching condition comprising:
receiving, by the second storing system, the account number name and the account number mode of the account number from the first storing system;
determining, by the second storing system, whether the second storing system stores a record satisfying a first determining condition, the first determining condition comprising that an account number mode and an account number name in a primary key of the record are identical with the account number mode and the account number name of the account number respectively;
if there is no record satisfying the first determining condition, determining, by the second storing system, that the account number satisfies the reverse-searching condition; and
if there is the record satisfying the first determining condition, determining, by the second storing system, that the account number does not satisfy the reverse-searching condition;
and wherein when the reverse-searching condition comprises the account number name of the account number is unique in both the account number mode of the account number and at least one other account number mode, determining, by the second storing system, whether the account number satisfies the preset reverse-searching condition comprising:
receiving, by the second storing system, the account number name and the account number mode of the account number from the first storing system;
determining, by the second storing system, whether the second storing system stores a record satisfying a second determining condition, the second determining condition comprising that: an account number mode in a primary key of the record is identical with the account number mode of the account number or is identical with the at least one other account number mode, and an account number name in the primary key of the record is identical with the account number name of the account number;
if there is no record satisfying the second determining condition, determining, by the second storing system, that the account number satisfies the reverse-searching condition; and
if there is a record satisfying the second determining condition, determining, by the second storing system, that the account number does not satisfy the reverse-searching condition.

6. The method of claim 5, wherein the account number mode in the record is indicated by using a preset integer,
and wherein determining, by the second storing system, whether the second storing system stores the record satisfying the first determining condition comprising:
calculating, by the second storing system, a hash value according to an integer corresponding to the account number mode of the account number and the account number name of the account number;
searching out, by the second storing system, a storing unit corresponding to the hash value from all storing units of the second storing system; and
determining, by the second storing system, whether the storing unit searched out stores the record satisfying the first determining condition;
and wherein determining, by the second storing system, whether the second storing system stores the record satisfying the second determining condition comprising:
mapping, by the second storing system, the integer corresponding to the account number mode of the account number to an integer according to a preset mapping rule;
calculating, by the second storing system, a hash value according to the mapped integer and the account number name of the account number;
searching out, by the second storing system, a storing unit corresponding to the hash value from all storing units of the second storing system; and
determining, by the second storing system, whether the storing unit searched out stores the record satisfying the second determining condition;
and wherein the method further comprises storing, by the second storing system, the record comprising:
storing, by the second storing system, the record generated in the storing unit corresponding to the hash value.

7. The method of claim 1, further comprising:
searching for, by the second storing system, the account number ID according to the account number mode of the account number and the account number name of the account number.

8. The method of claim 7, wherein
when the reverse-searching condition comprises: the account number name of the account number being unique in the account number mode of the account number, searching for, by the second storing system, the account number ID according to the account number mode of the account number and the account number name of the account number comprising:
calculating, by the second storing system, a hash value according to the integer corresponding to the account number mode of the account number and the account number name of the account number;
searching out, by the second storing system, a storing unit corresponding to the hash value from all storing units of the second storing system;
determining, by the second storing system, whether the storing unit searched out stores a record, an account number mode and an account number name in a primary key of the record being identical with the account number mode and the account number name of the account number respectively; and
if the storing unit searched out stores the record, taking an account number ID in the record as an account number ID searched out;
and wherein when the reverse-searching condition comprises the account number name of the account number being unique in both the account number mode of the account number and at least one other account number mode, searching for, by the second storing system, the account number ID according to the account number mode of the account number and the account number name of the account number comprising:
mapping, by the second storing system, an integer corresponding to the account number mode of the account number to a preset integer;
calculating, by the second storing system, a hash value according to the mapped integer and the account number name of the account number;
searching out, by the second storing system, a storing unit corresponding to the hash value from all storing units of the second storing system;
determining, by the second storing system, whether the storing unit searched out stores a record, an account number mode and an account number name in a primary key of the record being identical with the account number mode and the account number name of the account number respectively; and
if the storing unit searched out stores the record, taking an account number ID in the record as an account number ID searched out.

9. A first storing system, comprising:
a first processing module, to send an account number and an account number ID, after obtaining the account number corresponding to the account number ID; and
a second processing module, to receive the account number and the account number ID from the first processing module, wherein the second processing module is further to:
when determining the account number satisfies a preset reverse-searching condition, determine whether the first storing system stores a record corresponding to the account number ID;
if the first storing system does not store the record corresponding to the account number ID, generate and store a record, a primary key of the record being the account number ID, and a value of the record being an account number mode of the account number and an account number name of the account number; and
if the first storing system stores the record corresponding to the account number ID, take an account number mode of the account number and an account number name of the account number as a value, and add the value into the record corresponding to the account number ID.

10. The first storing system of claim 9, wherein the reverse-searching condition comprises:
the account number name of the account number being unique in the account number mode of the account number; or
the account number name of the account number being unique in both the account number mode of the account number and at least one other account number mode.

11. The first storing system of claim 9, wherein
the second processing module is further to prompt a user to modify the account number name of the account number when determining the account number does not satisfy the reverse-searching condition.

12. The first storing system of claim 9, wherein the second processing module is further to:
if the account number name of the account number does not need to be unique, determine whether the first storing system stores the record corresponding to the account number ID;
if the first storing system does not store the record corresponding to the account number ID, generate and store a record, a primary key of the record being the account number ID, and a value of the record is the account number mode and account number name of the account number; and
if the first storing system stores the record corresponding to the account number ID, take an account number mode of the account number and an account number name of the account number as a value and add the value to the record corresponding to the account number ID.

13. A second storing system, comprising:
a third processing module, to obtain an account number and an account number ID from a first storing system, and send the account number and the account number ID; and
a fourth processing module, to:
receive the account number and the account number ID from the third processing module; and
when determining the account number satisfies a preset reverse-searching condition, generate and store a record, a primary key of the record being an account number mode of the account number and an account number name of the account number, and a value of the record is the account number ID, the record being used when searching for the account number ID according to the account number mode of the account number and the account number name of the account number.

14. The second storing system of claim 13, wherein the reverse-searching condition comprises:
the account number name of the account number being unique in the account number mode of the account number; or
the account number name of the account number being unique in both the account number mode of the account number and at least one other account number mode,
wherein when the reverse-searching condition comprises the account number name of the account number being unique in the account number mode of the account number the fourth processing module is to:
determine whether the second storing system stores a record satisfying a first determining condition, the first determining condition comprising that an account number mode and an account number name in a primary key of the record are identical with the account number mode and the account number name of the account number respectively;
if there is no record satisfying the first determining condition, determine that the account number satisfies the reverse-searching condition; and
if there is the record satisfying the first determining condition, determine that the account number does not satisfy the reverse-searching condition,
and wherein when the reverse-searching condition comprises the account number name of the account number is unique in both the account number mode of the account number and at least one other account number mode the fourth processing module is to:
determine whether the second storing system stores a record satisfying a second determining condition, the second determining condition comprising that an account number mode in a primary key of the record is identical with the account number mode of the account number or is identical with the at least one other account number mode, and an account number name in the primary key of the record is identical with the account number name of the account number;
if there is no record satisfying the second determining condition, determine that the account number satisfies the reverse-searching condition; and
if there is the record satisfying the second determining condition, determine that the account number does not satisfy the reverse-searching condition.

15. The second storing system of claim 14, wherein the account number mode in the record is indicated by using a preset integer,
and wherein the fourth processing module is to:
calculate a hash value according to the integer corresponding to the account number mode of the account number and the account number name of the account number;
search out a storing unit corresponding to the hash value from all storing units of the second storing system; and
determine whether the storing unit searched out stores the record satisfying the first determining condition; or the fourth processing module is to:
map the integer corresponding to the account number mode of the account number to an integer according to a preset mapping rule;
calculate a hash value according to the mapped integer and the account number name of the account number;
search out a storing unit corresponding to the hash value from all storing units of the second storing system; and
determine whether the storing unit searched out stores the record satisfying the second determining condition,
and wherein the fourth processing module is to store the record generated in the storing unit corresponding to the hash value.

16. The second storing system of claim 15, wherein the fourth processing module is further to search for the account number ID according to the account number mode of the account number and the account number name of the account number,
and wherein when the reverse-searching condition comprises: the account number name of the account number being unique in the account number mode of the account number, the fourth processing module is to:
calculate a hash value according to the integer corresponding to the account number mode of the account number and the account number name of the account number;
search out a storing unit corresponding to the hash value from all storing units of the second storing system;
determine whether the storing unit searched out stores a record, an account number mode and an account number name in a primary key of the record being identical with the account number mode and the account number name of the account number respectively; and
if the storing unit searched out stores the record, take an account number ID in the record as an account number ID searched out;
and wherein when the reverse-searching condition comprises the account number name of the account number being unique in both the account number mode of the account number and at least one other account number mode, the fourth processing module is to:
map an integer corresponding to the account number mode of the account number to a preset integer;
calculate a hash value according to the mapped integer and the account number name of the account number;
search out a storing unit corresponding to the hash value from all storing units of the second storing system;
determine whether the storing unit searched out stores a record, an account number mode and an account number name in a primary key of the record being identical with the account number mode and the account number name of the account number respectively; and
if the storing unit searched out stores the record, take an account number ID in the record as an account number ID searched out.
